(19) United States
(12) Patent Application Publication
(10) Pub. No.: US 2007/0196565 A1
(43) Pub. Date: Aug. 23, 2007

(54) Method for manufacturing magnetic recording medium

(75) Inventors: Takahiro Suwa, Tokyo (JP); Kazuya Shimakawa, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/709,049

(22) Filed: Feb. 22, 2007

(30) Foreign Application Priority Data
Feb. 23, 2006 (JP) 2006-47044

(51) Int. Cl. B05D 5/12; B05D 5/00

(52) U.S. Cl. 427/127; 427/270

(57) ABSTRACT

Provided is a method for manufacturing a magnetic recording medium that has a concavo-convex patterned recording layer, sufficient flatness, and excellent recording/reproducing properties. A filling material is deposited over a workpiece including a substrate; a recording layer formed over the substrate in a predetermined concavo-convex pattern of which convex portions are recording elements; and a detection material formed over the recording elements. Process gas is irradiated to the surface to remove a portion of the filling material and the detection material to flatten the surface. An element contained in the detection material removed and flying off is detected on the basis of its atomic mass number. The irradiation of the process gas is then stopped according to the detection result. The detection material contains an element selected from the group consisting of aluminum, yttrium, zirconium, niobium, rhodium, silver, terbium, tantalum, gold, bismuth, titanium, indium, and tungsten.

### BACKGROUND OF THE INVENTION

1. Field of the Invention

The present invention relates to a method for manufacturing a magnetic recording medium having a recording layer formed in a predetermined concavo-convex pattern.

2. Description of the Related Art

The areal density of magnetic recording media such as hard disks has increased significantly in recent years. The increase has been achieved by the production of fine magnetic particles to form a recording layer, better choice of materials and high-precision processing of the magnetic head, and this increase is expected to continue. However, it is extremely difficult to further increase the areal density using conventional approaches because of problems, e.g., limits to fine processing of the magnetic head, incorrect recording of data on tracks adjacent to a target track caused by the fringe field of the magnetic head, and reproducing error due to crosstalk.

Consequently, discrete track media and patterned media, which have a recording layer formed in a concavo-convex pattern of which convex portions are recording elements, have been proposed as magnetic recording media that enable further improvement in the areal density. On the other hand, surface flatness is important for magnetic recording media such as hard disks to maintain a constant head flying height. Consequently, a proposed technique deposits a filling material over recording elements to fill the concave portions between the recording elements and then flattens the top surface of the recording elements and the filling material (see Japanese Patent Laid-Open Publication No. Hei 9-97419, for example).

As a technique for forming the recording layer in a concavo-convex pattern, dry etching can be used. As techniques for depositing the filling material, sputtering, chemical vapor deposition (CVD), and ion beam deposition (IBD) can be used. As a technique for flattening the top surface of the recording elements and the filling material, dry etching can be used. The filling material is deposited over the concavo-convex recording layer to fill the concave portions using the depositing technique, and the filling material above the top surface (the surface further away from the substrate) of the recording elements, i.e., the surplus filling material, is then removed using the flattening technique.

In order to obtain good magnetic properties of the recording layer, it is preferable to remove the surplus filling material completely but without processing the top surface of the recording elements. In other words, it is preferable for the flattening step to control dry etching so that the etch endpoint coincides with the top surface of the recording elements.

When a portion of the recording elements is removed from a workpiece by dry etching, elements contained in the portion flying off can be detected by secondary ion mass spectrometry (SIMS) and quadrupole mass spectroscopy (QMS). Therefore, if etching is stopped when a target element is detected, etch endpoint variations can be reduced to within a few nanometers from the top surface of the recording elements. It should be noted that secondary ion mass spectrometry and quadrupole mass spectroscopy identify elements contained in a detection material on the basis of their atomic mass number.

However, the detection of elements from the recording elements by secondary ion mass spectrometry and quadrupole mass spectroscopy requires etching of not only the surplus filling material but also the recording elements. Consequently, a top portion of the recording elements will be etched by a thickness of at least a few nanometers, and this sometimes degrades their magnetic properties.

In semiconductor technology, a known technique comprises having a detection material deposited on a layer to be protected from etching, which corresponds to the recording elements, and detecting elements contained in the detection material to stop the etching (see Japanese Patent Laid-Open Publication No. 2003-078185, for example).

Application of this semiconductor technique to magnetic recording media is expected. Specifically, in order to remove the surplus filling material without etching the recording elements, the detection material is deposited on the recording layer having a concavo-convex pattern, etching proceeds to the detection material, and then the etching is stopped immediately after either detecting elements contained in the detection material starting to be removed and flying off or the disappearance of such elements that have previously been detected.

However, some elements have isotopes that have a different atomic mass number each other. Moreover, in some cases, atoms of different elements have the same atomic mass number. Therefore, if atoms of an objective element have an atomic mass number that is not one to be detected, i.e., if the atoms are isotopes other than the one to be detected, those atoms are not detected as the objective element by secondary ion mass spectrometry and quadrupole mass spectroscopy. Also, atoms of a different element that has an atomic mass number matching that of an objective element to be detected can be incorrectly detected as the objective element by secondary ion mass spectrometry and quadrupole mass spectroscopy even though the atoms are not of the target element. Accordingly, it is difficult in some cases to precisely determine the time when etching of the detection material starts or the time when the detection material is completely removed.

For these reasons, even when etching is stopped on the basis of detecting elements contained in the detection material, the detection material may not actually have been etched at all or the etching may have proceeded to the recording elements after the detection material has been completely removed.

Because the recording element and the filling material generally differ in material and etch rate, if the filling material that fills the concave portions between the recording elements is etched together with the recording elements, they may form a step of a few nanometers between the top surface of the recording elements and the top surface of the filling material. With discrete track media and patterned media, which have high areal density, even such a small step may cause problems such as a head crash because these media require a low head flying height of about 5 to 15 nm. This step of a few nanometers may be formed not only in the manufacturing process of magnetic recording media but also in the manufacturing process of semiconductor. However, semiconductor devices generally have no mechanical component such as a magnetic head causing head crash, and thus are not affected by such a small step.

### SUMMARY OF THE INVENTION

In view of the foregoing problems, various exemplary embodiments of this invention provide a method for manufacturing a magnetic recording medium, by which a magnetic recording medium having a concavo-convex recording layer, sufficient flatness, and excellent recording/reproducing properties can be manufactured.

Various exemplary embodiments of the present invention achieve the aforementioned object by a method including the steps of: depositing a filling material over a workpiece including a substrate, a recording layer formed over the substrate in a predetermined concavo-convex pattern of which convex portions are recording elements, and a detection material formed at least over the recording elements to fill concave portions between the recording elements; irradiating a surface of the workpiece with process gas to remove at least a portion of the filling material and a portion of the detection material which are above a top surface of the recording elements to flatten the surface of the workpiece; and detecting an element contained in the detection material removed from and flying off the workpiece on the basis of its atomic mass number, and stopping irradiation with the process gas on the basis of a result of detection of the element contained in the detection material. The detection material contains an element selected from the group consisting of aluminum, yttrium, zirconium, niobium, rhodium, silver, terbium, tantalum, gold, bismuth, titanium, indium, and tungsten.

Moreover, various exemplary embodiments of the present invention achieves the aforementioned object by a method including the steps of: depositing a second filling material over a workpiece including a substrate, a recording layer formed over the substrate in a predetermined concavo-convex pattern of which convex portions are recording elements, a first filling material formed over the recording layer to at least partially fill concave portions between the recording elements, and a detection material formed over the first filling material; irradiating a surface of the workpiece with process gas to remove at least a portion of any of the first filling material, the detection material, and the second filling material, the portion being above a top surface of the recording elements to flatten the surface of the workpiece; and detecting an element contained in the detection material removed from and flying off the workpiece on the basis of its atomic mass number, and stopping irradiation with the process gas on the basis of a result of detection of the element contained in the detection material. The detection material contains an element selected from the group consisting of aluminum, yttrium, zirconium, niobium, rhodium, silver, terbium, tantalum, gold, bismuth, titanium, indium, and tungsten.

Aluminum, yttrium, niobium, rhodium, terbium, gold, and bismuth each have only one atomic mass number, i.e., have no isotopes. Each of Zirconium, silver, and tantalum has several isotopes but its major isotope, i.e., the most occurring isotope in nature among isotopes of each element, has unique atomic mass number and no atom of the other elements has the same atomic mass number as it. Titanium, indium, and tungsten each have several isotopes, and their major isotopes have the same atomic mass number as isotopes of other elements: calcium, tin, and osmium. The isotopes of calcium, tin, and osmium which have the same atomic mass number as the major isotopes of titanium, indium, and tungsten, however, they rarely occur in nature compared with all other isotopes of calcium, tin, and osmium.

Accordingly, identifying the detection material on the basis of the atomic mass number of aluminum, yttrium, niobium, rhodium, terbium, gold, and bismuth or the atomic mass number of the major isotopes of zirconium, silver, tantalum, titanium, indium, and tungsten allows precise detection of etching of the detection material.

Accordingly, various exemplary embodiments of this invention provide a method for manufacturing a magnetic recording medium, comprising a filling material deposition step of depositing a filling material over a workpiece including a substrate, a recording layer formed over the substrate in a predetermined concavo-convex pattern of which convex portions are recording elements, and a detection material formed at least over the recording elements, to fill concave portions between the recording elements with the filling material; a flattening step of irradiating a surface of the workpiece with process gas to remove at least a portion of the filling material and a portion of the detection material which are above a top surface of the recording elements to flatten the surface of the workpiece, and detecting an element contained in the detection material removed from and flying off the workpiece on the basis of its atomic mass number, and stopping irradiation with the process gas on the basis of a result of detection of the element contained in the detection material, wherein the filling material deposition step and the flattening step being carried out in this order, and the detection material contains an element selected from the group consisting of aluminum, yttrium, zirconium, niobium, rhodium, silver, terbium, tantalum, gold, bismuth, titanium, indium, and tungsten.

Moreover, various exemplary embodiments of this invention provide a method for manufacturing a magnetic recording medium, comprising a second filling material deposition step of depositing a second filling material over a workpiece including a substrate, a recording layer formed over the substrate in a predetermined concavo-convex pattern of which convex portions are recording elements, a first filling material formed over the recording layer to at least partially fill concave portions between the recording elements, and a detection material formed over the first filling material; a flattening step of irradiating a surface of the workpiece with process gas to remove at least a portion of any of the first filling material, the detection material, and the second filling material, the portion being above a top surface of the recording elements to flatten the surface of the workpiece, detecting an element contained in the detection material removed from and flying off the workpiece on the basis of its atomic mass number, and stopping irradiation with the process gas on the basis of a result of detection of the element contained in the detection material, wherein the second filling material deposition step and the flattening step being carried out in this order, and the detection material contains an element selected from the group consisting of aluminum, yttrium, zirconium, niobium, rhodium, silver, terbium, tantalum, gold, bismuth, titanium, indium, and tungsten.

The phrase “recording layer formed over the substrate in a predetermined concavo-convex pattern of which convex portions are recording elements” is used to mean not only a recording layer with a predetermined pattern into which a continuous recording layer is divided, but also a recording layer formed over parts of a substrate, such as a recording layer having recording elements with track shape which are joined at their ends, or a recording layer having a spiral recording element; a continuous recording layer having concave portions formed partway through its thickness with the surface on the substrate side being continuous; a continuous recording layer following the surface of a substrate or an underlying layer of a concavo-convex pattern; and a recording layer which is divided into sections formed only over the top surface of the convex portions and over the bottom surface of concave portions of a substrate or an underlying layer in a concavo-convex pattern.

The phrase “detection material formed over the recording elements” is used to mean not only a detection material formed directly on and in contact with the recording elements, but also a detection material formed indirectly over the recording elements through a layer directly formed on the recording elements.

The phrase “a top surface of the recording elements” is used to mean a surface of the recording layer opposite to or furthest away from the substrate.

The term “magnetic recording medium” is used to mean not only media in which data is recorded and reproduced by magnetism, such as hard disks, floppy™ disks, and magnetic tapes, but also magneto-optical recording medium for which light and magnetism are used, such as magneto-optical disks, and heat-assisted magnetic recording medium for which heat and magnetism are used.

The present invention makes it possible to manufacture a magnetic recording medium that has a concavo-convex patterned recording layer, sufficient flatness, and excellent recording/reproducing properties.

### BRIEF DESCRIPTION OF THE DRAWINGS

FIG. 1 is a schematic cross-sectional side view showing the structure of a starting body of a workpiece according to a first exemplary embodiment of the present invention;

FIG. 2 is a schematic cross-sectional side view showing a structure of a magnetic recording medium which is obtained by processing the workpiece;

FIG. 3 shows a flowchart showing an outline of manufacturing steps of the magnetic recording medium;

FIG. 4 is a schematic cross-sectional side view showing a concavo-convex pattern transferred on a resist layer of the starting body of the workpiece;

FIG. 5 is a schematic cross-sectional side view showing the workpiece with a detection material deposited thereon;

FIG. 6 is a schematic cross-sectional side view showing the workpiece with a filling material deposited thereon;

FIG. 7 is a schematic cross-sectional side view showing the workpiece with a detection material over recording elements etched in a flattening step;

FIG. 8 is a schematic cross-sectional side view showing a workpiece with detection material according to a second exemplary embodiment of the present invention, the detection materials being deposited only over recording elements;

FIG. 9 is a schematic cross-sectional side view showing the workpiece with the detection material over the recording elements etched in a flattening step;

FIG. 10 is a schematic cross-sectional side view showing a workpiece with a detection material deposited thereon according to a third exemplary embodiment of the present invention;

FIG. 11 is a schematic cross-sectional side view showing the workpiece with a second filling material deposited thereon;

FIG. 12 is a schematic cross-sectional side view showing the workpiece with the detection material over recording elements etched in a flattening step; and

FIG. 13 is a schematic cross-sectional side view showing the workpiece with the detection material over concave portions etched in the flattening step.

### DETAILED DESCRIPTION OF THE PREFERRED EMBODIMENTS

Preferred exemplary embodiments of the present invention will be described in detail below with reference to the drawings.

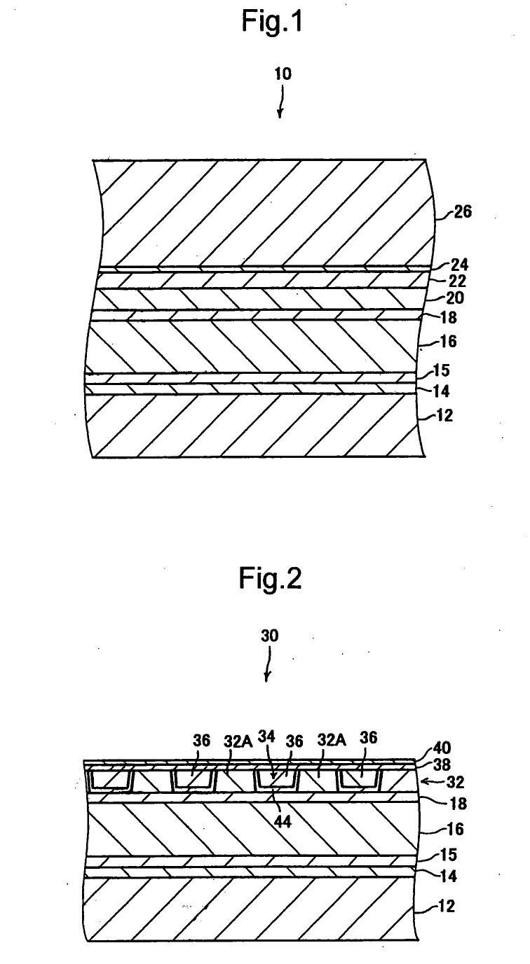

A first exemplary embodiment of the present invention relates to a method for manufacturing a magnetic recording medium 30 as shown in FIG. 2. Specifically, a starting body of a workpiece 10, composed of a substrate 12, a continuous recording layer 20 formed over the substrate 12, and so on as shown in FIG. 1, is processed, so that the continuous recording layer 20 is divided into many recording elements 32A to form a recording layer 32 in a predetermined concavo-convex pattern. The workpiece 10 is then processed to have a detection material 44 over the recording layer 32. A filling material 36 is deposited over the detection material 44 to fill concave portions 34 between the recording elements 32A. The surplus detection material 44 and the surplus filling material 36, which are above the top surface of the recording elements 32A, are removed so that the surface is flattened. The detection material 44 has distinct characteristics. The other steps are thought not to be essential to the understanding of the first exemplary embodiment and thus will be omitted in the following descriptions as appropriate.

The starting body of the workpiece 10 as shown in FIG. 1 is composed of an underlayer 14, an antiferromagnetic layer 15, a soft magnetic layer 16, a seed layer 18, the continuous recording layer 20, a first mask layer 22, a second mask layer 24, and a resist layer 26, which are deposited in this order over the substrate 12.

The substrate 12 is made of, for example, glass or Al₂O₃. The underlayer 14 is 2 to 40 nm in thickness and made of, for example, tantalum. The antiferromagnetism layer 15 is 5 to 50 nm in thickness and made of, for example, a Pt—Mn alloy or a Ru—Mn alloy. The soft magnetic layer 16 is 50 to 300 nm in thickness and made of an iron alloy or a cobalt alloy. The seed layer 18 is 2 to 40 nm in thickness and made of, for example, a nonmagnetic Co—Cr alloy, titanium, ruthenium, a laminate of tantalum and ruthenium, or MgO.

The continuous recording layer 20 is 5 to 30 nm in thickness and made of a Co—Cr alloy. The first mask layer 22 is 3 to 50 nm in thickness and made of carbon. The second mask layer 24 is 1 to 30 nm in thickness and made of nickel. The resist layer 26 is 30 to 300 nm in thickness and made of resin.

The magnetic recording medium 30 is a perpendicular discrete track recording medium.

Many recording elements 32A of the recording layer 32 are formed in shape of concentric tracks in a data area and finely spaced in the radial direction. Incidentally, the recording elements 32A are formed in a predetermined servo pattern, including contact holes, in a servo area.

The filling material 36 is made of, for example, SiO₂. The filling material 36 is preferably a nonmagnetic material. The filling material 36 is preferably an oxide material.

A protective layer 38 and a lubricant layer 40 are deposited in this order over the recording elements 32A and the filling material 36. The protective layer 38 is made of a hard carbon film, called diamond-like carbon. The lubricant layer 40 is made of perfluoropolyether (PFPE).

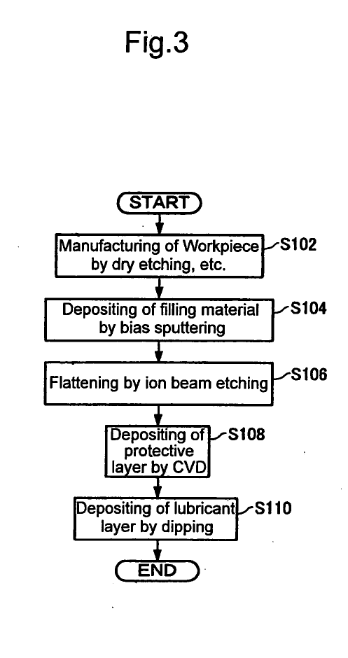

The method for manufacturing the magnetic recording medium 30 will be described below with reference to a flowchart shown in FIG. 3.

A step of manufacturing a workpiece is first performed (S102). Specifically, the starting body of the workpiece 10 shown in FIG. 1 is processed to manufacture the workpiece 10 as shown in FIG. 5, which has the recording layer 32 formed over the substrate 12 in the concavo-convex pattern of which convex portions are the recording elements 32A; and the detection material 44 deposited over the recording layer 32.

The starting body of the workpiece 10 is obtained by depositing the underlayer 14, the antiferromagnetism layer 15, the soft magnetic layer 16, the seed layer 18, the continuous recording layer 20, the first mask layer 22, and the second mask layer 24 in this order over the substrate 12 by sputtering and applying the resist layer 26 by spin-coating.

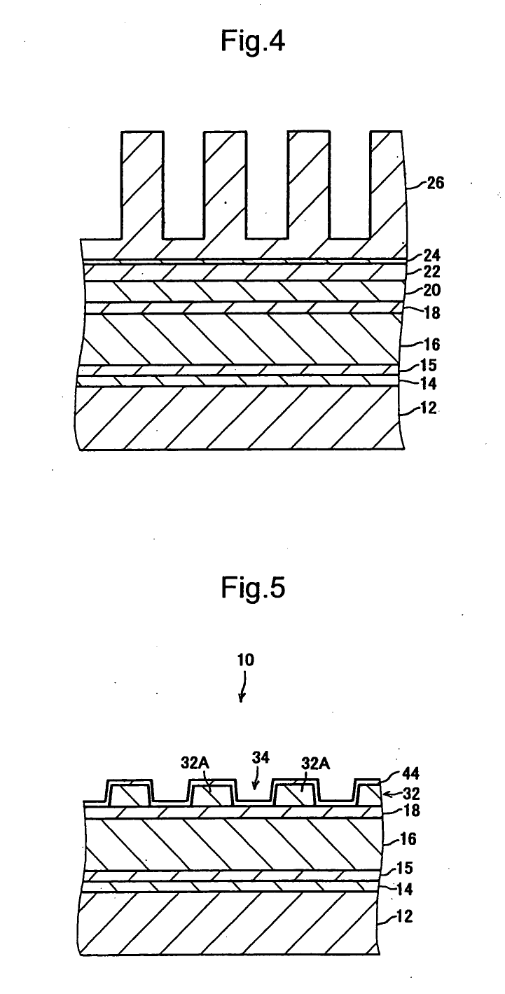

On the resist layer 26 of the starting body, a concavo-convex pattern corresponding to the concavo-convex pattern of the recording layer 32 is transferred with a stamper (not shown) by nano-imprinting as shown in FIG. 4. Parts of the resist layer 26 under the bottom of the concave portions are removed by reactive ion beam etching using O₂ or O₃ as reactive gas. Alternatively, the resist layer 26 may be exposed and developed, and thus processed into the concavo-convex pattern.

Parts of the second mask layer 24 under the bottom of the concave portions are then removed by ion beam etching using argon gas. Parts of the first mask layer 22 under the bottom of the concave portions are then removed by reactive ion etching using SF₆ gas. Next, parts of the continuous recording layer 20 under the bottom of the concave portions are removed by ion beam etching using argon gas and thus the continuous recording layer 20 is divided into many recording elements 32A. The remaining portions of the first mask layer 22 over the recording elements 32A are removed by reactive ion etching using SF₆ gas.

Next, a non-oxide material is deposited over the recording layer 32 to form the detection material 44. The non-oxide material contains an element selected from the group consisting of aluminum, yttrium, zirconium, niobium, rhodium, silver, terbium, tantalum, gold, bismuth, titanium, indium, and tungsten. Alternatively, the detection material 44 may be a material containing an oxide of an element selected from the group consisting of aluminum, yttrium, zirconium, niobium, rhodium, silver, terbium, tantalum, gold, bismuth, titanium, indium, and tungsten such as Al₂O₃. A metal element contained in the detection material 44 is preferably only one element selected from the group consisting of aluminum, yttrium, zirconium, niobium, rhodium, silver, terbium, tantalum, gold, bismuth, titanium, indium, and tungsten. The detection material 44 preferably consists of, for example, either only one element selected from the group consisting of aluminum, yttrium, zirconium, niobium, rhodium, silver, terbium, tantalum, gold, bismuth, titanium, indium, and tungsten or only one oxide of one of these elements. The detection material 44 may contain a minute amount of other elements or other compounds but preferably does not contain an element contained in the recording layer 32 or filling material 36.

The detection material 44 is deposited over the top surface and side surfaces of the recording elements 32A and the bottom surface of the concave portions 34, following the surface topography (concave and convex surfaces) of the recording layer 32. The detection material 44 preferably has a thickness of 5 nm or less for manufacturing efficiency.

As a result, the workpiece 10 is provided as shown in FIG. 5, which includes the substrate 12, the recording layer 32 formed in the concavo-convex pattern of which the convex portions are the recording elements 32A, and the detection material 44 formed over the recording layer 32.

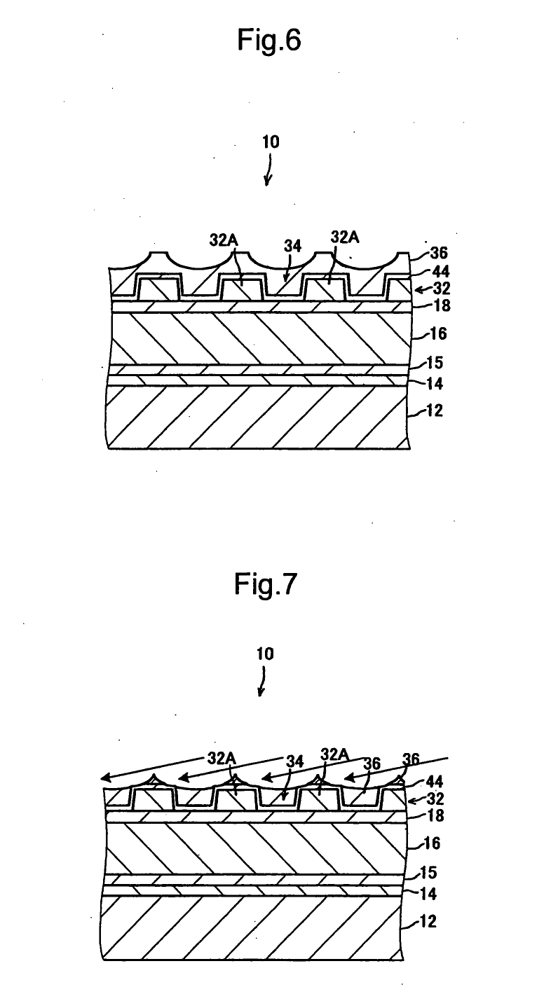

A step of depositing a filling material is next performed (S104). Specifically, the filling material 36 is deposited over the detection material 44 by bias sputtering as shown in FIG. 6. In general, the particles of the filling material 36 are uniformly deposited over the surface of the workpiece 10, forming a concavo-convex surface. However, by the bias sputtering, which applies a bias voltage to the workpiece 10, the sputtering gas is attracted to the workpiece 10 and thus strikes the already deposited filling material 36, etching away a portion of the filling material 36. Since this etching effect tends to selectively remove edge portions of a projecting portion of the deposited filling material 36 faster than the other portion (the surrounding non-projecting portion), the convex portion of the surface over the recording elements 32A is reduced in width relative to the recording elements 32A. The deposition has a greater effect than the etching, which allows the deposition to proceed while mitigating the recesses and protrusions on the surface. The filling material 36 is made of, for example, SiO₂.

If the detection material 44 is formed by depositing a non-oxide material, the filling material 36 is preferably an oxide material such as SiO₂. This is because when an oxide filling material 36 is deposited on and in contact with the top surface of the non-oxide detection material 44, oxygen in the filling material 36 diffuses into the detection material 44, thereby oxidizing a top surface portion of the detection material 44.

A flattening step is next performed (S106). Specifically, process gas such as argon is irradiated to the surface of the workpiece 10 in a direction inclined from normal to the surface, as shown by the arrows in FIG. 7, thereby removing portions of the detection material 44 and filling material 36 above the top surface of the recording elements 32A (the surface opposite to or furthest away from the substrate 12). The irradiation of process gas in a direction inclined from normal to the surface of the workpiece 10 makes it easy to remove the convex portions prior to the concave portions.

Meanwhile, an element contained in the detection material 44 removed from and flying off the workpiece 10 is detected by secondary ion mass spectrometry, quadrupole mass spectroscopy, and the like, and the irradiation with process gas is stopped on the basis of the detection result and thus etching is stopped. For example, the irradiation with process gas may be stopped and thus etching is stopped at the point in time when the element contained in the detection material 44 is first detected, or when the element contained in the detection material 44 is detected up to a predetermined reference amount, or when the element that have been previously detected substantially disappear (become undetectable).

Alternatively, the irradiation with process gas may be stopped a certain period of time after the element contained in the detection material 44 is detected up to a predetermined reference amount.

As shown in Table 1, aluminum, yttrium, niobium, rhodium, terbium, gold, and bismuth each have only one atomic mass number, i.e., have no isotopes. Each of zirconium, silver, and tantalum has several isotopes but its major isotope, i.e., the most occurring isotope in nature among isotopes of each element, has unique atomic mass number and no atom of the other elements has the same atomic mass number as it.

Titanium has several isotopes; the major isotope has an atomic mass number of 48, which is the same as that of an isotope of calcium. However, the natural abundance ratio of calcium 48 to all atoms of calcium is as low as about 0.19%. Indium also has several isotopes; the major isotope has an atomic mass number of 115, which is the same as that of an isotope of tin. However, the natural abundance ratio of tin 115 to all atoms of tin is as low as about 0.4%. Tungsten also has several isotopes; the major isotope has an atomic mass number of 186, which is the same as that of an isotope of osmium. However, the natural abundance ratio of osmium 186 to all atoms of osmium is as low as about 1.6%.

TABLE 1

| | Mass | Abundance | |
|---|---|---|---|
| | number | ratio of | Other element |
| | of major | major isotope | with the same |
| Element | isotope | [%] | mass number |
| Al | 27 | 100 | — |
| Y | 89 | 100 | — |
| Zr | 90 | 51.5 | — |
| Nb | 93 | 100 | — |
| Rh | 103 | 100 | — |
| Ag | 107 | 51.8 | — |
| Tb | 159 | 100 | — |
| Ta | 181 | 99 or more | — |
| Au | 197 | 100 | — |
| Bi | 209 | 100 | — |
| Ti | 48 | 73.8 | Ca(0.19%) |
| In | 115 | 95.7 | Sn(0.4%) |
| W | 186 | 28.6 | Os(1.6%) |

Accordingly, identifying the detection material 44 flying off on the basis of either the atomic mass number of one element selected from the group consisting of aluminum, yttrium, niobium, rhodium, terbium, gold, and bismuth or the atomic mass number of the major isotopes, having the highest natural abundance ratio, of zirconium, silver, tantalum, titanium, indium, and tungsten, allows precise detection of etching of the detection material 44.

Secondary ion mass spectrometry and quadrupole mass spectroscopy have higher sensitivity to elements of an oxide etched off than to the pure element etched off. Accordingly, if the detection material 44 is made of a material containing an oxide of an element selected from the group consisting of aluminum, yttrium, zirconium, niobium, rhodium, silver, terbium, tantalum, gold, bismuth, titanium, indium, and tungsten such as Al₂O₃, then larger amount of an element of the detection material 44 will be detected. Alternatively, if the detection material 44 is made of a non-oxide material of an element selected from the group consisting of aluminum, yttrium, zirconium, niobium, rhodium, silver, terbium, tantalum, gold, bismuth, titanium, indium, and tungsten while the filling material 36 of oxide is deposited on the detection material 44 to oxidize a top surface portion thereof, also in this case, larger amount of an element of the detection material 44 will be detected. Incidentally, even when all or a part of the detection material 44 is an oxide material, the detection material 44 flying off is detected on the basis of either the atomic mass number of one element selected from the group consisting of aluminum, yttrium, niobium, rhodium, terbium, gold, and bismuth or the atomic mass number of the major isotopes, having the highest natural abundance ratio, of zirconium, silver, tantalum, titanium, indium, and tungsten.

The etch rates of Al₂O₃, zirconium, niobium, tantalum, and tungsten in ion beam etching are relatively low. Accordingly, using a detection material 44 containing Al₂O₃, zirconium, niobium, tantalum or tungsten makes it easy to control the timing of stopping the ion beam etching, bringing the etch endpoint very precisely to the target point near the top surface of the recording elements 32A.

The etch rates of Al₂O₃, zirconium, niobium, tantalum, and tungsten and the etch rate of the filling material 36, SiO₂, under the following etching conditions for the ion beam etching are shown in Table 2.

Process gas: Ar
Beam current: 1100 mA
Beam voltage: 700 V
Ion beam incident angle: 2°

TABLE 2

| | Etch rate |
|---|---|
| Material | [nm/min] |
| Al₂O₃ | 5.2 |
| Zr | 3.6 |
| Nb | 2.2 |
| Ta | 2.0 |
| W | 1.9 |
| SiO₂ | 15.0 |

The convex portions of Al₂O₃, zirconium, niobium, tantalum, and tungsten are easily removed prior to their concave portions in ion beam etching. Accordingly, using a detection material 44, containing Al₂O₃, zirconium, niobium, tantalum, or tungsten, makes it possible to improve the flattening effect.

As a result, since etching of the detection material 44 is detected with high sensitivity, the etching can be very precisely stopped near the top surface of the recording elements 32A.

Next, the protective layer 38 with a thickness of 1 to 5 nm is deposited over the recording elements 32A and filling material 36 (S108). The lubricant layer 40 with a thickness of 1 to 2 nm is then deposited over the protective layer 38 by dipping (S110). Thus, the magnetic recording medium 30 shown in FIG. 2 is completed. Although portions of the detection material 44 remain within the concave portions 34, the remaining portions have no effect on the magnetic properties of the recording layer 32. This is because aluminum, yttrium, zirconium, niobium, rhodium, silver, terbium, tantalum, gold, bismuth, titanium, indium, and tungsten are nonmagnetic and their oxides are also nonmagnetic.

A second exemplary embodiment of the present invention is described below.

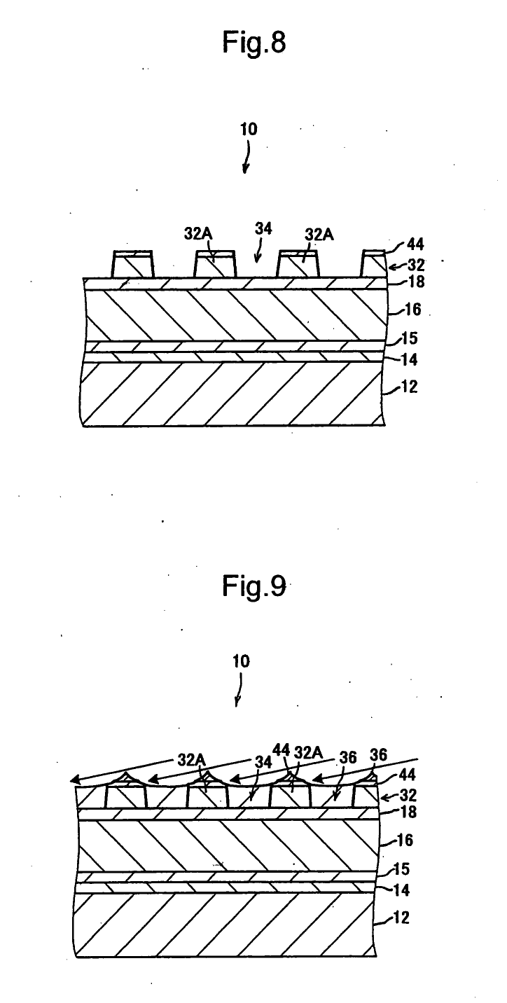

According to the first exemplary embodiment, in the step of manufacturing the workpiece 10 (step S102), the continuous recording layer 20 is processed into the recording layer 32 with a concavo-convex pattern; the remaining portions of the first mask layer 22 on the recording elements 32A are removed; the detection material 44 is then deposited over the recording layer 32; and thus the detection material 44 is formed over not only the top surface of the recording elements 32A but also the side surfaces of the recording elements 32A and the bottom surface of the concave portions 34. By contrast, according to the second exemplary embodiment, the first mask layer is made of a material containing an element selected from the group consisting of aluminum, yttrium, zirconium, niobium, rhodium, silver, terbium, tantalum, gold, bismuth, titanium, indium, and tungsten. Moreover, in the step of manufacturing the workpiece 10 (S102) of the second exemplary embodiment, the remaining portions of the first mask layer over the recording elements 32A are not removed and serves as the detection material 44; and the detection material 44 is formed only over the top surface of the recording elements 32A as shown in FIG. 8. In particular, the detection material 44 does not remain within the concave portions 34.

The other features are the same as those of the first exemplary embodiment, and thus denoted by the same reference numerals, and the explanation thereof is omitted as appropriate.

Even when the remaining portions of the first mask layer over the recording elements 32A are not removed and serves as the detection material 44, etching of the detection material 44 as shown in FIG. 9 allows an element contained in the detection material 44 to be detected with high sensitivity. As a result, the etching can be very precisely stopped at the target point near the top surface of the recording elements 32A.

A third exemplary embodiment of the present invention is described below.

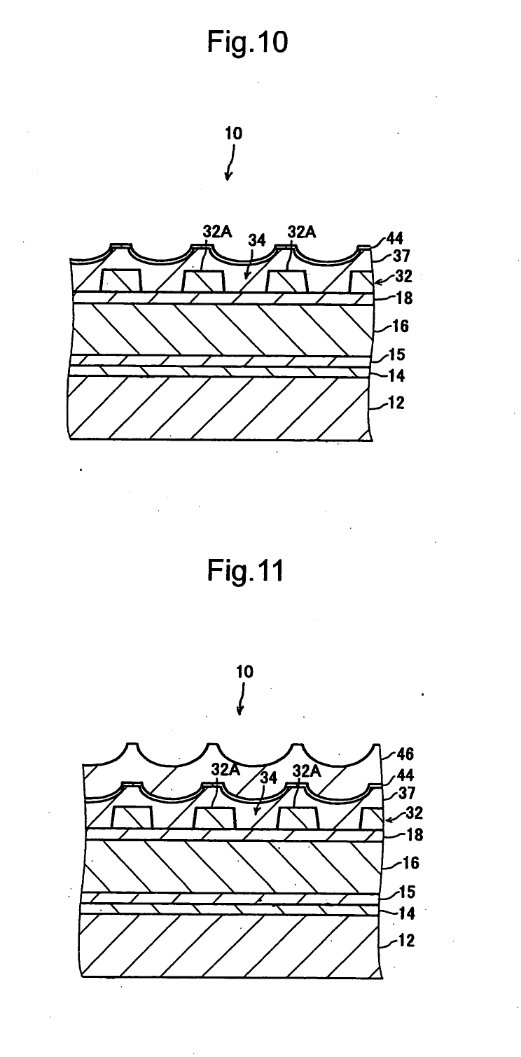

According to the first exemplary embodiment, in the step of manufacturing the workpiece 10 (S102), the detection material 44 is formed directly on the recording layer 32. By contrast, according to the third exemplary embodiment, a first filling material 37 is deposited over the recording layer 32 to fill the concave portions 34, and the detection material 44 is then formed over the first filling material 44, as shown in FIG. 10. The other features are the same as those of the first exemplary embodiment, and thus denoted by the same reference numerals, and the explanation thereof is omitted as appropriate.

Specifically, in the step of manufacturing the workpiece 10 (S102), the first filling material 37 is deposited over the recording layer 32 by bias sputtering with a thickness greater than the depth of the concave portions 34 (more than thickness of the recording elements 32A) so as to completely fill the concave portions 34. The first filling material 37 is made of, for example, SiO₂, like the filling material 36 of the first exemplary embodiment. The first filling material 37 is deposited over the recording layer 32 while mitigating the recesses and protrusions on the surface thereof. A non-oxide material like that of the first exemplary embodiment is then deposited over the first filling material 37 by sputtering, and thus the detection material 44 is formed. Consequently, the workpiece 10 is provided as shown in FIG. 10, which is composed of the substrate 12, the recording layer 32 formed over the substrate 12 in a predetermined concavo-convex pattern of which convex portions are the recording elements 32A; the first filling material 37 formed over the recording layer 32 to fill the concave portions 34 between the recording elements 32A; and the detection material 44 formed over the first filling material 37.

Next, in the step of depositing a filling material (S104), a second filling material 46 is deposited over the detection material 44 as shown in FIG. 11. The second filling material 46 is made of, for example, SiO₂, like the first filling material 37. If the detection material 44 is made of a non-oxide material and the first filling material 37 and second filling material 46 are made of an oxide material, oxygen in the first filling material 37 and second filling material 46 is diffused into the detection material 44, thereby oxidizing top and bottom surface portions of the detection material 44.

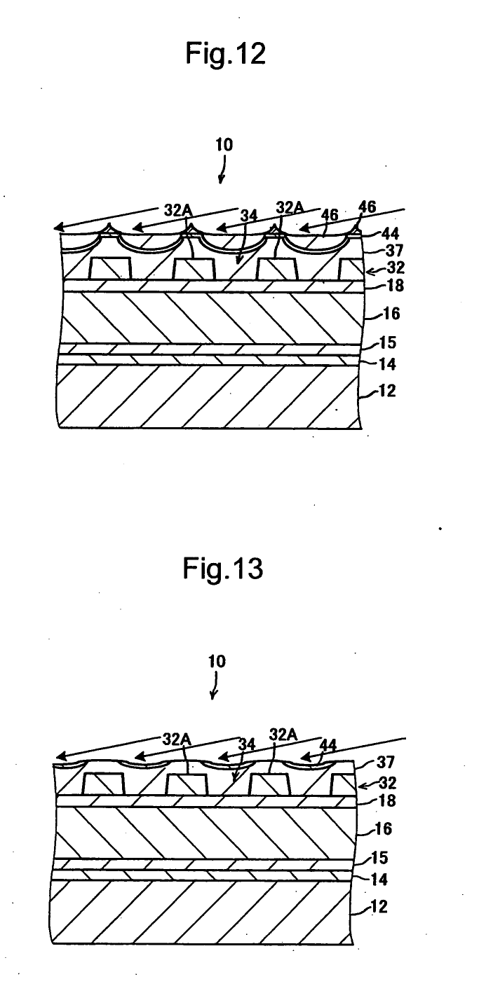

Next, in the flattening step (S106), process gas such as argon is irradiated to the surface of the workpiece 10 in a direction inclined from normal to the surface, as shown by the arrows in FIG. 12, thereby removing portions of the first filling material 37, detection material 44, and second filling material 46 above the top surface of the recording elements 32A (the surface opposite to or furthest away from the substrate 12).

Meanwhile, as in the first exemplary embodiment, an element contained in the detection material 44 removed from and flying off the workpiece 10 are detected by secondary ion mass spectrometry, quadrupole mass spectroscopy, and the like, the irradiation with process gas is stopped on the basis of the detection result and thus etching is stopped.

Specifically, most of the detection material 44 is etched simultaneously after the detection material 44 over the concave portions 34 is exposed as shown in FIG. 13. This makes much greater amounts of the element contained in the detection material 44 to fly off at this point. Thus, the element contained in the detection material 44 can be clearly detected.

If the detection material 44 is formed by depositing a non-oxide material over the first filling material 37, and the first filling material 37 and second filling material 46 are made of an oxide material, oxygen in the first filling material 37 and second filling material 46 is diffused into the detection material 44, thereby oxidizing top and bottom surface portions of the detection material 44. Thus, particularly while the top and bottom surface portions of the detection material 44 are being etched, the element contained in the detection material 44 can be clearly detected. Specifically, an oxide second filling material 46 oxidizes a top surface portion of the detection material 44, thereby making it easy to detect the point in time when the detection material 44 starts flying off. Moreover, an oxide first filling material 37 oxidizes a bottom surface portion of the detection material, thereby making it easy to detect the point in time when the last detection material 44 disappears.

Also, according to the third exemplary embodiment, the etching of the detection material 44 is detected with high sensitivity, so that it can be very precisely stopped at the target point near the top surface of the recording elements 32A.

In the third exemplary embodiment, the first filling material 37 with a thickness more than the depth of the concave portions 34 is deposited to completely fill the concave portions 34. Alternatively, the first filling material 37 with a thickness less than the depth of the concave portions 34 may be deposited, and the detection material 44 and second filling material 46 may be deposited over the first filling material 37 to completely fill the concave portions 34. In this case, the irradiation with process gas is stopped on the basis of the detection result of the element contained in the detection material 44 over the recording elements 32A, and thus etching is stopped.

When the first filling material 37 with a thickness more than the depth of the concave portions 34 is deposited to completely fill the concave portions 34, the second filling material 46 deposited over the detection material 44 does not fill the concave portions 34. However, even in this case, the material deposited over the detection material 44 is referred in the specification to as “the second filling material” for convenience.

In the first to the third exemplary embodiments, SiO₂ is shown as an example of the filling material 36, first filling material 37, and second filling material 46, but these materials are not limited to SiO₂. Nevertheless, if the detection material 44 is formed by depositing a non-oxide material, the filling material 36, first filling material 37, and second filling material 46 are preferably an oxide material.

In the first to the third exemplary embodiments, ion beam etching using argon gas is shown as an example of dry etching used in the flattening step (S106). Alternatively, other dry etching that irradiates the surface of the workpiece with process gas may be used. Such other dry etching includes ion beam etching using other rare gas such as krypton or xenon, reactive ion etching using halogen-containing reactive gas such as SF₆, CF₄, or C₂F₆, and reactive ion beam etching using mixture gas of reactive gas and rare gas. The process gas is preferably irradiated to the surface of the workpiece in a direction inclined from the normal line of the surface.

In the first to the third exemplary embodiments, secondary ion mass spectrometry and quadrupole mass spectroscopy are shown as examples of methods of detecting an element contained in the detection material 44 removed from and flying off the workpiece 10 in the flattening step (S106). Alternatively, other detection method that can detect aluminum, yttrium, zirconium, niobium, rhodium, silver, terbium, tantalum, gold, bismuth, titanium, indium, and tungsten based on their atomic mass number with great accuracy, may be used.

In the first to the third exemplary embodiments, the filling material 36, first filling material 37, and second filling material 46 are deposited by bias sputtering. Alternatively, other deposition method may be used. Other deposition method includes sputtering without applying a bias voltage, chemical vapor deposition (CVD), and ion beam deposition (IBD).

In the first to the third exemplary embodiments, the surface of the workpiece 10 is flattened only in the flattening step (S106). However, an additional flattening step may be performed. For example, another layer may be deposited after the flattening step (S106) and then an additional flattening by dry etching or the like may be performed.

In the first to the third exemplary embodiments, the continuous recording layer 20 (recording elements 32A) is made of a Co—Cr alloy. However, the continuous recording layer 20 may be made of other materials, for example, other alloy containing an iron-group element such as cobalt, iron, and nickel, or a laminate of them.

In the first and the second exemplary embodiments, the detection material 44 is formed directly over and in contact with the recording elements 32A. However, the detection material 44 may be formed indirectly over the recording elements 32A through another layer formed over the recording elements 32A, as in the third exemplary embodiment.

In the first to the third exemplary embodiments, the underlayer 14, antiferromagnetic layer 15, soft magnetic layer 16, and seed layer 18 are provided under the continuous recording layer 20. However, the layer structure under the continuous recording layer 20 may be changed as appropriate depending on types of magnetic recording media. For example, the magnetic recording medium may not have one or more of the underlayer 14, antiferromagnetism layer 15, soft magnetic layer 16, and seed layer 18. The continuous recording layer may be formed directly on the substrate.

In the first to the third exemplary embodiments, the magnetic recording medium 30 has a multilayer structure in which the layers such as the recording layer 32 are formed on one side of the substrate 12. However, the present invention can be applicable to manufacturing of a dual-sided magnetic recording medium having recording layers on both sides of the substrate.

In the first to the third exemplary embodiments, the magnetic recording medium 30 is a discrete track perpendicular recording medium of which the recording layer 32 is divided at fine intervals in the radial direction of track. However, the present invention can be applicable to manufacturing of other types of magnetic recording media. Other types include magnetic recording medium of which recording layer is divided at fine intervals in the circumferential direction of track (sector direction), patterned medium of which recording layer is divided at fine intervals in both radial and circumferential directions of track, pre-embossed recording medium (PERM) having a concavo-convex continuous recording layer, and magnetic recording medium having a spiral recording layer. The present invention can be applied to a manufacturing of magnetic recording medium having a recording layer of longitudinal recording type. The other types also include magneto-optical disk, heat-assisted magnetic recording disk for which heat and magnetism are used, and non-disk type magnetic recording medium having a concavo-convex recording layer, such as magnetic tapes.

The present invention is useful for manufacturing of magnetic recording medium having a concavo-convex recording layer, such as discrete track medium and patterned medium.

What is claimed is:

1. A method for manufacturing a magnetic recording medium, comprising:
a filling material deposition step of depositing a filling material over a workpiece including a substrate, a recording layer formed over the substrate in a predetermined concavo-convex pattern of which convex portions are recording elements, and a detection material formed at least over the recording elements to fill concave portions between the recording elements with the filling material;
a flattening step of irradiating a surface of the workpiece with process gas to remove at least a portion of the filling material and a portion of the detection material which are above a top surface of the recording elements to flatten the surface of the workpiece, and detecting an element contained in the detection material removed from and flying off the workpiece on the basis of its atomic mass number, and stopping irradiation with the process gas on the basis of a result of detection of the element contained in the detection material,
wherein the filling material deposition step and the flattening step being carried out in this order,
and the detection material contains an element selected from the group consisting of aluminum, yttrium, zirconium, niobium, rhodium, silver, terbium, tantalum, gold, bismuth, titanium, indium, and tungsten.

2. A method for manufacturing a magnetic recording medium, comprising:
a second filling material deposition step of depositing a second filling material over a workpiece including a substrate, a recording layer formed over the substrate in a predetermined concavo-convex pattern of which convex portions are recording elements, a first filling material formed over the recording layer to at least partially fill concave portions between the recording elements, and a detection material formed over the first filling material;
a flattening step of irradiating a surface of the workpiece with process gas to remove at least a portion of any of the first filling material, the detection material, and the second filling material, the portion being above a top surface of the recording elements, to flatten the surface of the workpiece, detecting an element contained in the detection material removed from and flying off the workpiece on the basis of its atomic mass number, and stopping irradiation with the process gas on the basis of a result of detection of the element contained in the detection material,
wherein the second filling material deposition step and the flattening step being carried out in this order,
and the detection material contains an element selected from the group consisting of aluminum, yttrium, zirconium, niobium, rhodium, silver, terbium, tantalum, gold, bismuth, titanium, indium, and tungsten.

3. The method for manufacturing a magnetic recording medium according to claim 1, wherein
a non-oxide material is deposited at least over the recording elements of the recording layer to form the detection material, and the filling material is made of an oxide material.

4. The method for manufacturing a magnetic recording medium according to claim 2, wherein
a non-oxide material is deposited over the first filling material to form the detection material, and at least one of the first filling material and the second filling material is made of an oxide material.

5. The method for manufacturing a magnetic recording medium according to claim 1, wherein
the detection material is formed by depositing a material containing an oxide of an element selected from the group consisting of aluminum, yttrium, zirconium, niobium, rhodium, silver, terbium, tantalum, gold, bismuth, titanium, indium, and tungsten.

6. The method for manufacturing a magnetic recording medium according to claim 2, wherein
the detection material is formed by depositing a material containing an oxide of an element selected from the group consisting of aluminum, yttrium, zirconium, niobium, rhodium, silver, terbium, tantalum, gold, bismuth, titanium, indium, and tungsten.

7. The method for manufacturing a magnetic recording medium according to claim 1, wherein
a metal element contained in the detection material is only one element selected from the group consisting of aluminum, yttrium, zirconium, niobium, rhodium, silver, terbium, tantalum, gold, bismuth, titanium, indium, and tungsten.

8. The method for manufacturing a magnetic recording medium according to claim 2, wherein
a metal element contained in the detection material is only one element selected from the group consisting of aluminum, yttrium, zirconium, niobium, rhodium, silver, terbium, tantalum, gold, bismuth, titanium, indium, and tungsten.

9. The method for manufacturing a magnetic recording medium according to claim 3, wherein
a metal element contained in the detection material is only one element selected from the group consisting of aluminum, yttrium, zirconium, niobium, rhodium, silver, terbium, tantalum, gold, bismuth, titanium, indium, and tungsten.

10. The method for manufacturing a magnetic recording medium according to claim 4, wherein
a metal element contained in the detection material is only one element selected from the group consisting of aluminum, yttrium, zirconium, niobium, rhodium, silver, terbium, tantalum, gold, bismuth, titanium, indium, and tungsten.

11. The method for manufacturing a magnetic recording medium according to claim 5, wherein
a metal element contained in the detection material is only one element selected from the group consisting of aluminum, yttrium, zirconium, niobium, rhodium, silver, terbium, tantalum, gold, bismuth, titanium, indium, and tungsten.

12. The method for manufacturing a magnetic recording medium according to claim 6, wherein
a metal element contained in the detection material is only one element selected from the group consisting of aluminum, yttrium, zirconium, niobium, rhodium, silver, terbium, tantalum, gold, bismuth, titanium, indium, and tungsten.

13. The method for manufacturing a magnetic recording medium according to claim 1, wherein
in the flattening step, the element contained in the detection material is detected on the basis of the atomic mass number of the element by one of secondary ion mass spectrometry and quadrupole mass spectroscopy.

14. The method for manufacturing a magnetic recording medium according to claim 2, wherein
in the flattening step, the element contained in the detection material is detected on the basis of the atomic mass number of the element by one of secondary ion mass spectrometry and quadrupole mass spectroscopy.

15. The method for manufacturing a magnetic recording medium according to claim 3, wherein
in the flattening step, the element contained in the detection material is detected on the basis of the atomic mass number of the element by one of secondary ion mass spectrometry and quadrupole mass spectroscopy.

16. The method for manufacturing a magnetic recording medium according to claim 4, wherein
in the flattening step, the element contained in the detection material is detected on the basis of the atomic mass number of the element by one of secondary ion mass spectrometry and quadrupole mass spectroscopy.

17. The method for manufacturing a magnetic recording medium according to claim 5, wherein
in the flattening step, the element contained in the detection material is detected on the basis of the atomic mass number of the element by one of secondary ion mass spectrometry and quadrupole mass spectroscopy.

18. The method for manufacturing a magnetic recording medium according to claim 6, wherein
in the flattening step, the element contained in the detection material is detected on the basis of the atomic mass number of the element by one of secondary ion mass spectrometry and quadrupole mass spectroscopy.

19. The method for manufacturing a magnetic recording medium according to claim 7, wherein
in the flattening step, the element contained in the detection material is detected on the basis of the atomic mass number of the element by one of secondary ion mass spectrometry and quadrupole mass spectroscopy.

20. The method for manufacturing a magnetic recording medium according to claim 8, wherein
in the flattening step, the element contained in the detection material is detected on the basis of the atomic mass number of the element by one of secondary ion mass spectrometry and quadrupole mass spectroscopy.
